(19) United States
(12) Patent Application Publication
(10) Pub. No.: US 2019/0028494 A1
(43) Pub. Date: Jan. 24, 2019

(54) SYSTEM AND METHOD FOR CLOUD-CONNECTED AGENT-BASED NEXT-GENERATION ENDPOINT PROTECTION

(71) Applicant: ARIM Technologies Pte Ltd., Singapore (SG)

(72) Inventors: Liad Mizrachi, Singapore (SG); Ivan Goh, Singapore (SG)

(21) Appl. No.: 16/128,485

(22) Filed: Sep. 11, 2018

Related U.S. Application Data
(63) Continuation-in-part of application No. 16/006,801, filed on Jun. 12, 2018.
(60) Provisional application No. 62/518,577, filed on Jun. 12, 2017.
(60) Provisional application No. 62/518,567, filed on Jun. 12, 2017.

(51) Int. Cl. H04L 29/06

(52) U.S. Cl. CPC H04L 63/1416; H04L 63/1425; H04L 63/20

(57) ABSTRACT

A system for cloud-connected, agent-based, next-generation endpoint protection, comprising a next-generation endpoint protection software agent operating on the processor of a computing device, that collects process information for processes operating on the processor and transmits the process information to a remote remediation server, a remote mediation server that receives and analyzes the process information and sends instructions to the next-generation endpoint protection agent, and a method for cloud-connected, agent-based, next-generation endpoint protection.

### CROSS-REFERENCE TO RELATED APPLICATIONS

This application is a continuation-in-part of U.S. patent application Ser. No. 16/006,801, titled “NEXT-GENERATION ENHANCED COMPREHENSIVE CYBERSECURITY PLATFORM WITH ENDPOINT PROTECTION AND CENTRALIZED MANAGEMENT”, which was filed on Jun. 12, 2018, which claims benefit of, and priority to, U.S. provisional patent application Ser. No. 62/518,577, titled “Next-Generation Enhanced Comprehensive Cybersecurity Platform”, which was filed on Jun. 12, 2017, and also claims benefit of, and priority to, U.S. provisional patent application Ser. No. 62/518,567, titled “SYSTEM AND METHOD FOR CLOUD-CONNECTED AGENT-BASED NEXT-GENERATION ENDPOINT PROTECTION”, which was filed on Jun. 12, 2017, the entire specification of each of which is incorporated herein by reference.

### BACKGROUND

### Field of the Art

The disclosure relates to the field of cybersecurity, and more particularly to the field of endpoint protection within a network.

### Discussion of the State of the Art

Cybersecurity is a huge challenge for large enterprises and other organizations (government agencies, non-profits, and so forth). The current approach entails using many point solutions in an attempt to keep up with rapid changes in the threat environment, which opens many new opportunities “between the cracks” of point solutions for hostile actors to exploit. For example, in many organizations today, a Security Information and Event Management (SIEM) solution is like a “white elephant,” expensive to maintain and adding very little value to the overall security posture of the organization. Many organizations do not even reap 50% of the true potential of a SIEM solution, reducing it to a tool used for generating reports to satisfy auditors and to comply with regulatory requirements. Similarly, anti-virus solutions used in the marketplace as point solutions have largely failed, due to the delay in responding to zero-day attacks, and also because they are designed with a single threat profile in mind, with many evasive techniques available to malware users (e.g., evading signatures, evading scanners, evading heuristics, file splitting, zero-day exploits, sandbox evasion, obfuscation and encoding of malware, etc.).

What is clearly needed is cloud-connected, agent-based next-generation endpoint protection.

### SUMMARY

Accordingly, the inventor has conceived and reduced to practice, a system and method for cloud-connected agent-based next-generation endpoint protection.

According to one aspect, a system for cloud-connected, agent-based, next-generation endpoint protection, comprising: a next-generation endpoint protection software agent comprising at least a processor, a memory, and a plurality of programming instructions stored in the memory, the plurality of programming instructions, when executed by the processor, cause the processor to: collect process data comprising at least a plurality of processes operating on the processor; transmit at least a portion of the process information to a remote remediation server; receive instructions from a remote remediation server; stop a process from operating on the processor based on the instructions received; a remote mediation server comprising at least another processor, another memory, and another plurality of programming instructions stored in the another memory, the another plurality of programming instructions, when executed by the another processor, cause the another processor to: receive at least a plurality of process data from a next-generation endpoint protection software agent; analyze at least a portion of the process data; and transmit instructions to the next-generation endpoint protection software agent, the instructions being based at least in part on the results of the analysis, is disclosed.

According to another aspect, a method for cloud-connected, agent-based, next-generation endpoint protection, comprising the steps of: collecting, at a next-generation endpoint protection software agent comprising at least a processor, a memory, and a plurality of programming instructions stored in the another memory, process data comprising at least a plurality of processes operating on the processor; transmitting at least a portion of the process information to a remote remediation server; receiving, at a remote mediation server comprising at least another processor, another memory, and another plurality of programming instructions stored in the another memory, at least a plurality of process data from a next-generation endpoint protection software agent; analyzing at least a portion of the process data; and transmitting instructions to the next-generation endpoint protection software agent, the instructions being based at least in part on the results of the analysis, is disclosed.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for cloud-connected agent-based next-generation endpoint protection, according to one aspect.

FIG. 2 is a block diagram of a network endpoint, according to one aspect.

FIG. 3 is a flow diagram of an exemplary method for threat prevention, according to one aspect.

FIG. 4 is a flow diagram of an exemplary method for exploit detection, according to one aspect.

FIG. 5 is a flow diagram of an exemplary method for malware detection, according to one aspect.

FIG. 6 is a flow diagram of an exemplary method for threat mitigation, according to one aspect.

FIG. 7 is a flow diagram of an exemplary method for threat remediation, according to one aspect.

FIG. 8 is a flow diagram of an exemplary method for threat forensics, according to one aspect.

FIG. 9 is a block diagram illustrating an exemplary hardware architecture of a computing device.

FIG. 10 is a block diagram illustrating an exemplary logical architecture for a client device.

FIG. 11 is a block diagram showing an exemplary architectural arrangement of clients, servers, and external services.

FIG. 12 is another block diagram illustrating an exemplary hardware architecture of a computing device.

### DETAILED DESCRIPTION

The inventor has conceived, and reduced to practice, a system and method for cloud-connected agent-based next-generation endpoint protection.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

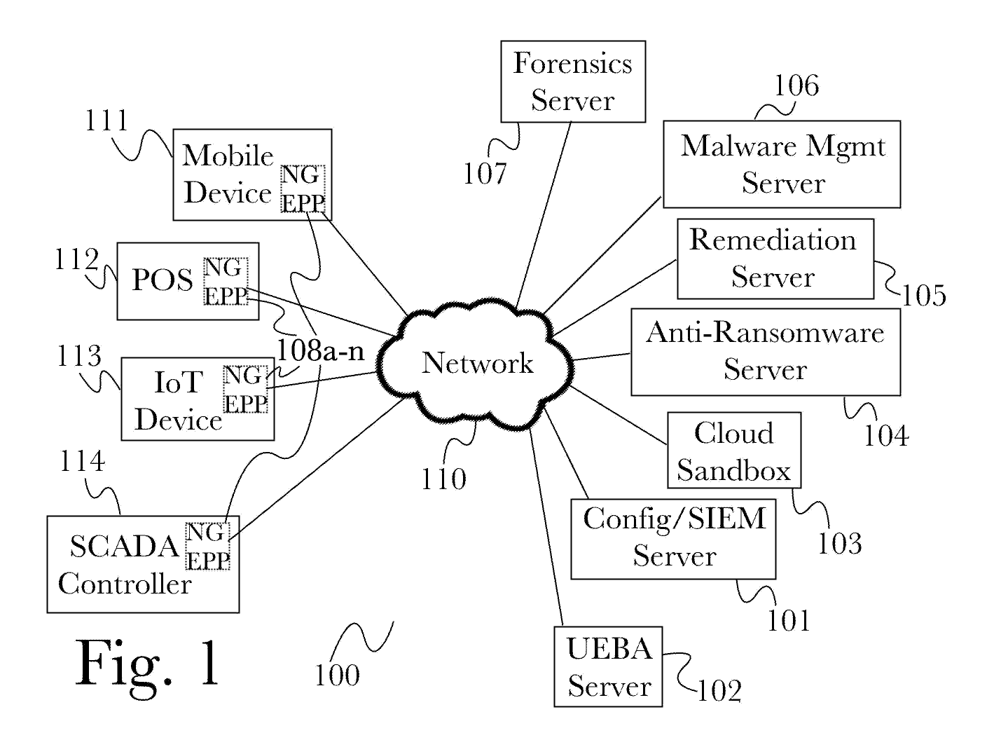

FIG. 1 is a block diagram illustrating an exemplary system architecture 100 for cloud-connected agent-based next-generation endpoint protection, according to one aspect. According to the aspect, a plurality of next-generation endpoint protection (NGEPP) software agents 108a-n may be deployed on a variety of endpoint devices (generally, any network-capable computing device) such as mobile devices 111 (for example, including but not limited to smartphones, tablets, smartwatches, or other personal mobile computing devices), point of sale equipment 112, Internet-of-Things (IoT) devices 113 (for example, including but not limited to smart TVs, appliances, power outlets or lighting switches, smart light bulbs, or other connected devices), controllers such as SCADA controllers 114 for infrastructure components (such as power, communications, or other utilities), laptop and desktop personal computers or workstations (not shown for simplicity and clarity), and so forth. A NGEPP agent 108a-n may also index files on a device for passive scanning in the background, or for selective scanning in the foreground such as when a suspicious process attempts to operate on or from a file on the device. NGEPP agents 108a-n may collect information from their respective host devices and provide it to various components of a next-generation enhanced comprehensive cybersecurity platform, and may receive information from the platform components via network 110. Potential threat events may be detected by NGEPP agent 108a-n, which may be configured to operate at an operating system kernel level or in the software user space on an endpoint device; threat responses may be initiated locally (at the endpoint device) and may be coordinated by one or more components of a next-generation enhanced comprehensive cybersecurity platform, via network 110. NGEPP agents 108a-n may be rapidly deployed through simple installers suited for the host endpoint, and require minimal user interaction or knowledge to facilitate ease of adoption.

Components used in a next-generation enhanced comprehensive cybersecurity platform may include, but are not limited to, one or more forensics servers 107 that may conduct remote forensic analysis of endpoints that have been or are suspected to have been attacked, one or more malware management servers 106 (that provide anti-virus services, whitelisting services, process hash databases, and the like), one or more remediation servers 105 that provide automated or semi-automated remediation actions (such as quarantine, file deletion, process stopping, and the like) in response to and remediation of hostile actions on one or more endpoint devices, one or more anti-ransomware servers 104 (that provide early warning, real-time intervention, and post-attach remediation services specific to ransomware attacks, including services such as secure central file backups for data protection, interception of improper user actions likely to inadvertently trigger a ransomware attack, and so forth), one or more cloud sandboxes 103 where files and services may be explored in a safe virtual environment, and one or more user- and entity-based analytics servers such as a security information and event management (SIEM) server 101 or a user and entity behavior analytics (UEBA) server 102, that provide in-depth analytics including enterprise baseline establishment and new threat detection, which may enable automated detection of, and response to, new zero-day exploits in the wild. A SIEM server 101 may also operate as a configuration server 101 that may be used to provide a centralized administration portal for administrative users to manage their agent installations, view statistics such as installation or usage counters or alerts and notifications, modify granular permissions or access or to modify their whitelists or blacklists used for threat detection, as described below. Administrators may optionally revoke per-user prompts, preventing users from manually enabling processes or files that may turn out to be malicious.

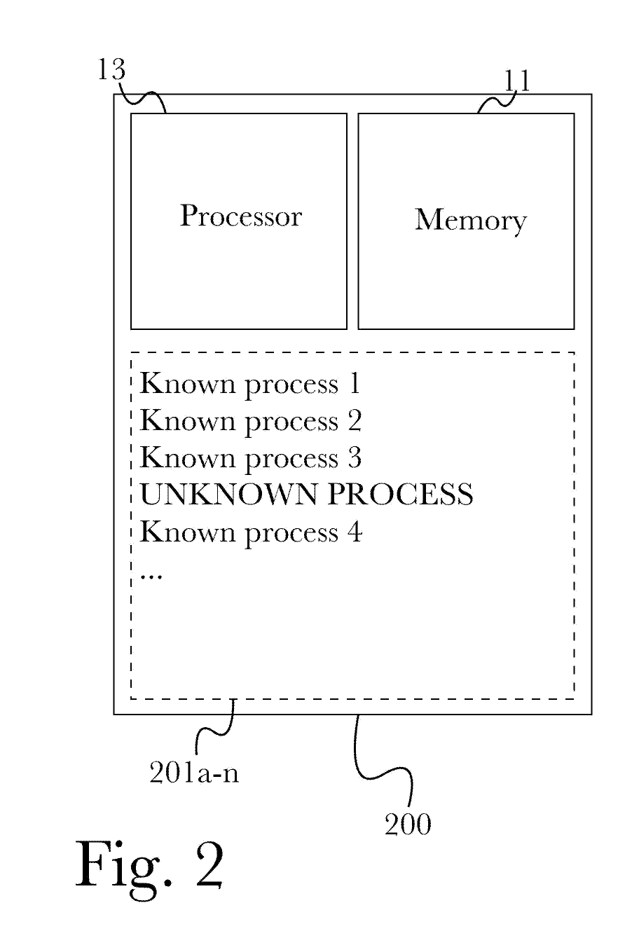

FIG. 2 is a block diagram of an exemplary network endpoint 200, according to one aspect. A network endpoint 200, such as (for example, including but not limited to) a mobile device or IoT sensor, may operate a NGEPP agent 108a-n to perform host-based intrusion prevention and detection by monitoring files and processes 201a-n operating on the processor 13 or stored in the memory 11 of the endpoint device 200. The NGEPP agent 108a-n may control whether a particular piece of executable code is allowed to execute or perform operations, offering options to a user via notification prompts to select a desired action when suspicious code attempts to run or perform system behaviors. A user may choose to permit the activity (allowing the code to run normally), deny the activity and block the code operation entirely, or “sandbox” the activity. When sandboxing an activity, the suspicious process or file may be sent to a cloud-based malware management server 106, that may then “explode the payload” of the code in question within a cloud sandbox 103, clicking links and accessing data within the code to simulate user interaction for signature-less examination, while observing the results in a safe environment (for example, clicking on links or opening files that may contain malware). A remediation server 105 may then provide instruction to the NGEPP agent 108a-n for handling any threats found, such as halting a process or quarantining or deleting unsafe files.

### Detailed Description of Exemplary Aspects

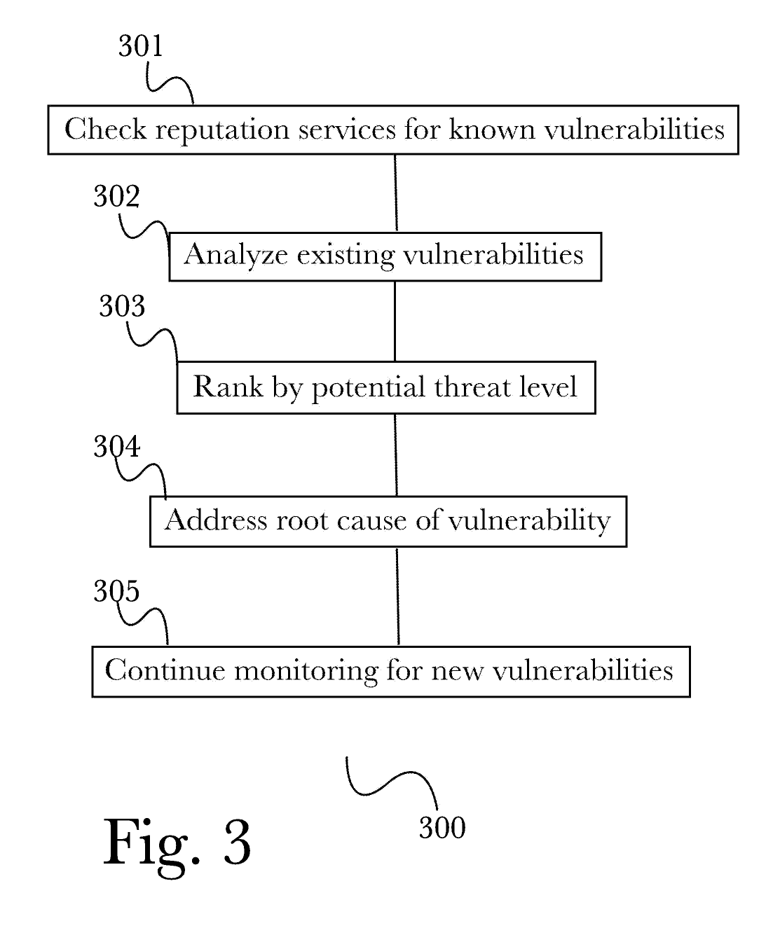

FIG. 3 is a flow diagram of an exemplary method 300 for threat prevention, according to one aspect. Vulnerability management is used to preemptively defend against the exploitation of vulnerabilities in company applications, software and networks. Implementing effective vulnerability or patch management tools can significantly reduce potential attack surface, keeping users safe from data breaches and theft. According to the aspect, a vulnerability management method 300 may comprise the steps of first 301 discovering existing vulnerabilities using any of a number of cloud-based reputation services rather than a single vulnerability database, and then 302 analyzing vulnerabilities and ranking them 303 according to potential threat level. This ranked threat list may then be used to mitigate 304 the root cause of a vulnerability, and maintain security through ongoing testing and security monitoring 305.

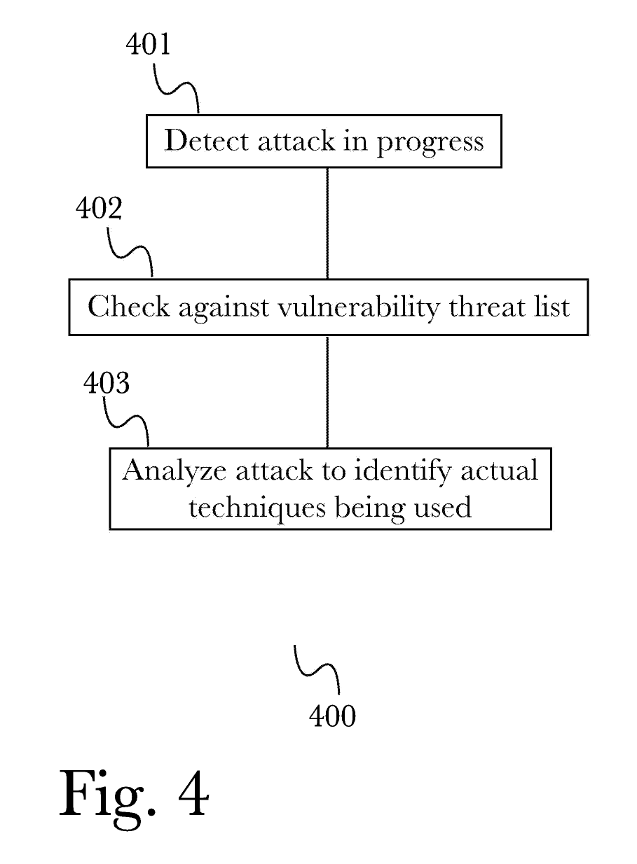

FIG. 4 is a flow diagram of an exemplary method 400 for exploit detection, according to one aspect. Using exploits to take advantage of code-level vulnerabilities is a sophisticated technique used by attackers to breach systems and execute malware, and “drive-by” software downloads are a common vector for carrying out such attacks. According to the aspect, an exploit detection method 400 may provide protection against both application and memory-based exploits, by first 401 detecting an attack and then 402 checking against a known vulnerability threat list (as described previously in FIG. 3) to determine the details of the particular attack. The attack may then be analyzed 403 in place on the device being attacked to identify the technique that is actually being used by the attack (for example, including but not limited to heap spraying, stack pivots, ROP attacks, or memory permission modifications).

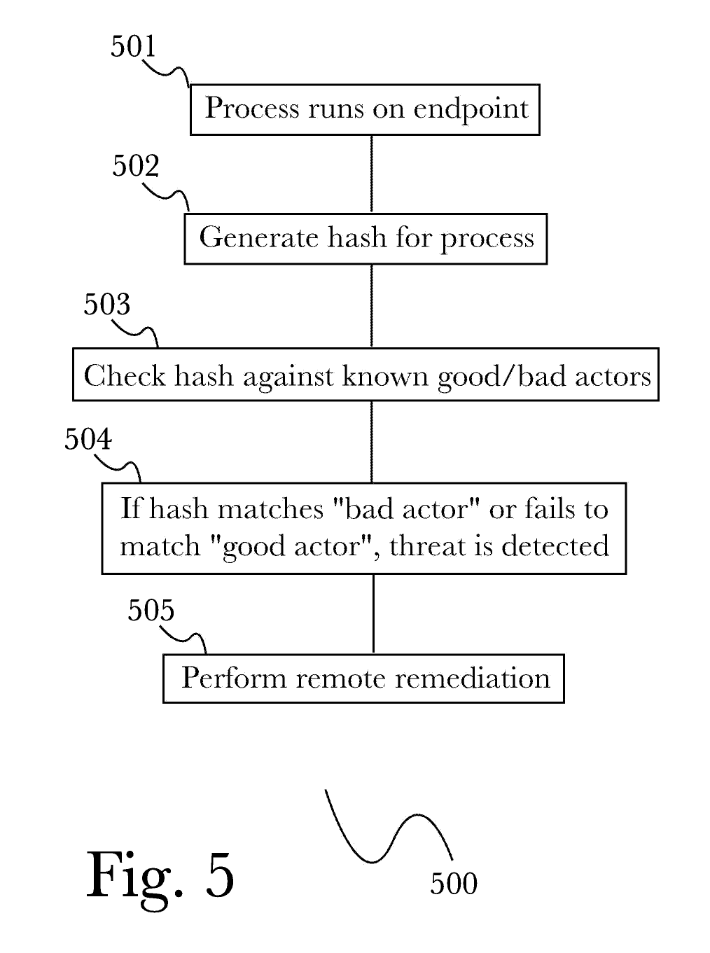

FIG. 5 is a flow diagram of an exemplary method 500 for malware detection, according to one aspect. According to the aspect, a global database may comprise a whitelist of known files or processes and a blacklist of known “bad actors”, against which files and processes may be checked for threat detection. When a process runs on an endpoint 501, a hash may be generated using a hashing algorithm 502 to produce a unique and reversible hash representing that specific process, which may then be checked against the global database 503. If a process has been tampered with or falsified, the hash will change and no longer match a previous entry in the whitelist, generating a threat detection 504. When a threat is found, remote remediation may be performed 505 by a remediation server 105 such as (for example) terminating a process or erasing a file without executing or accessing the contents, preventing any harm. This may also be performed using localized or client-specific whitelists or blacklists, for example for processes or files unique or proprietary to a particular corporation or for custom-tailored threat characteristics (for example, some users may have different considerations of what constitutes a threat).

To build a threat detection database, a baseline may be built over a set timeframe, wherein files and processes are hashed and added to a whitelist to automatically generate a whitelist for “normal operation” against which future hashes may be checked. If a new file or process is detected that is not on a local whitelist, it may be checked against a global whitelist to see if (for example) it is a legitimate process that simply did not run during the baselining process and thus was missed, or if it is indeed a malicious process. Unknown processes may generate an alert as described previously, prompting a user or administrator to manually allow, deny, or sandbox the potential threat. When sandboxed suspicious files or processes are determined to have carried an actual malicious payload, they may be added to a blacklist, enabling intelligent adaptation to new threats over time. This approach has a low occurrence of false results (whether positive or negative), and enables rapid detection of “zero-day” threats through the use of process white- and blacklisting.

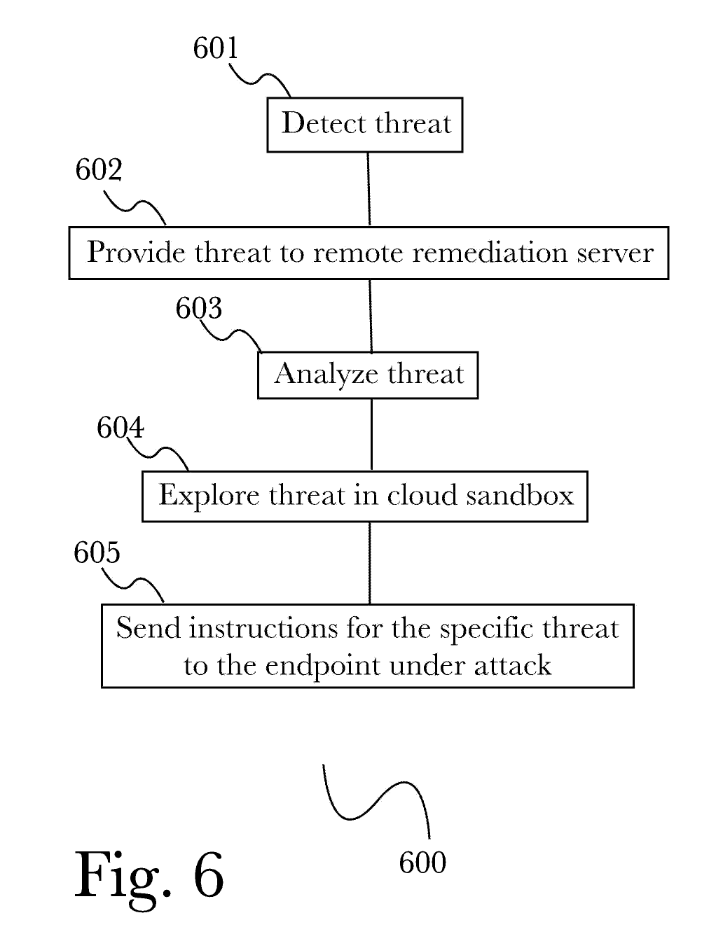

FIG. 6 is a flow diagram of an exemplary method 600 for threat mitigation, according to one aspect. Detecting a threat is a vital part of any protection process, but is not sufficient alone. When a threat is detected 601, it may be provided 602 to a remediation server 105 to be analyzed 603. Remediation server 105 may then address the threat in a suitable manner 604, for example by using a cloud sandbox 107 to fully explore the threat in a safe environment where it cannot do harm. Remediation server 105 may then send instructions to the endpoint under attack 605, directing it to perform actions to remediate the threat such as (for example, including but not limited to) quarantining or removing files or processes, shutting down a running process, or even shutting down the endpoint device itself if necessary. This provides an approach to threat mitigation that is flexible, addressing each threat on an individual basis rather than relying on policies that may not adequately apply to a particular attack, and it allows precise and effective mitigation based on the specific attack in progress by fully analyzing it and selecting a course of action that is most appropriate for that threat.

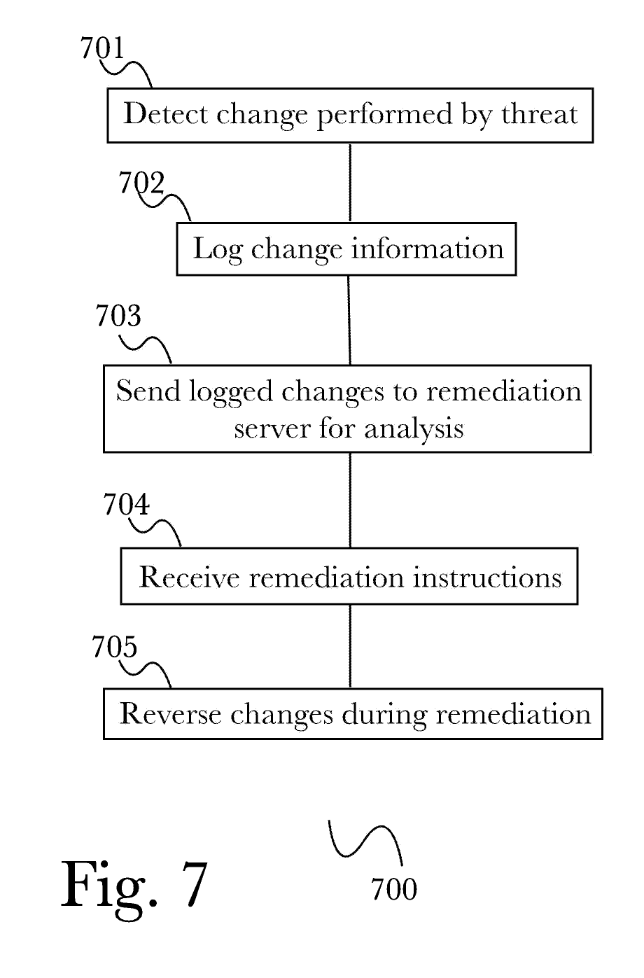

FIG. 7 is a flow diagram of an exemplary method 700 for threat remediation, according to one aspect. During execution of an attack, malware often creates, modifies, or deletes system file or registry resources, or changes configuration settings. To handle these effects of an attack, a NGEPP agent 108a-n may first detect a change 701, and then as part of a remediation process log the changes 702 and send 703 the log information to a remediation server 105 for use in analyzing the threat. When remediation instructions are received 704, part of a remediation process then includes reversing the changes performed by the threat 705, returning any files or resources to their original state.

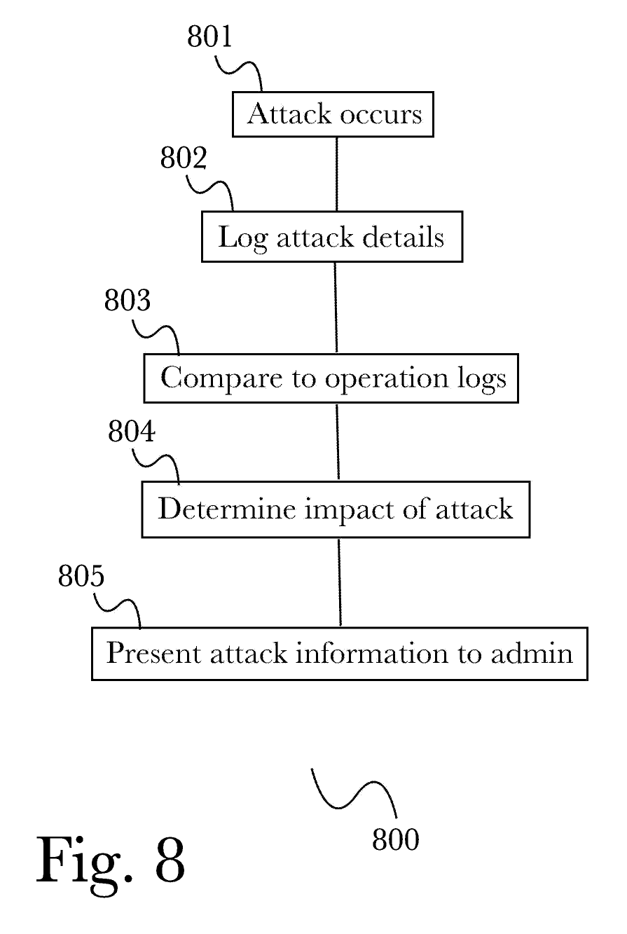

FIG. 8 is a flow diagram of an exemplary method 800 for threat forensics, according to one aspect. A NGEPP agent 108a-n may be used to provide real-time forensics after an attack (whether successful or not), to provide clear and timely visibility into malicious activity that may have taken place on an endpoint. According to the aspect, when an attack occurs 801, a NGEPP agent 108a-n may log the details of the attack 802 such as the threat level and any changes made (as described previously, referring to FIGS. 3 and 7). This may then be compared against logs of running processes and open files 803 to determine what changes took place and what the potential impact may be of a particular attack 804, to form a report that may then be provided to administrators via the network or optionally via a reporting view in an administration interface 805.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

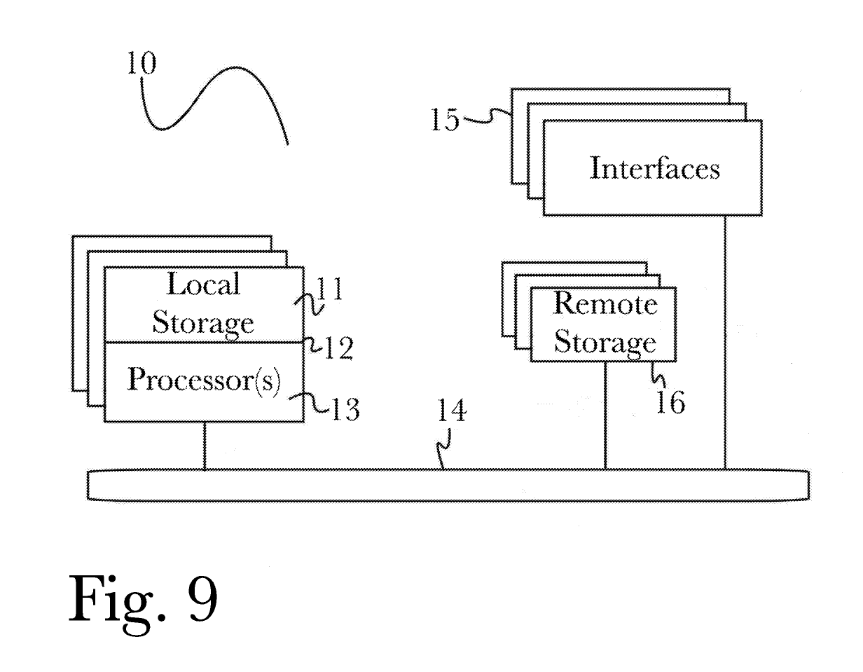

Referring now to FIG. 9, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 9 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

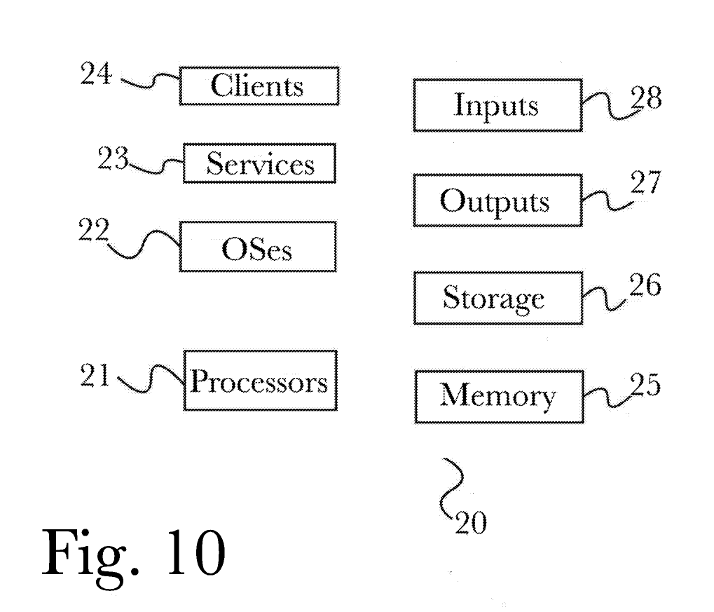

In some aspects, systems may be implemented on a standalone computing system. Referring now to FIG. 10, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 9). Examples of storage devices 26 include flash memory, magnetic hard drive, CD-ROM, and/or the like.

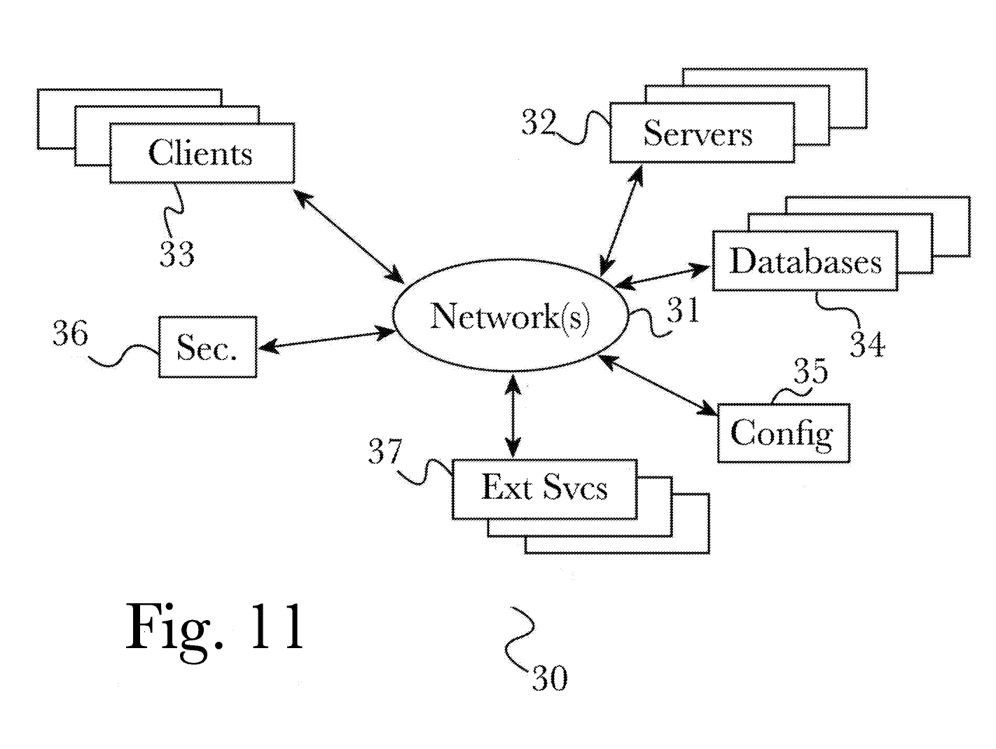

In some aspects, systems may be implemented on a distributed computing network, such as one having any number of clients and/or servers. Referring now to FIG. 11, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

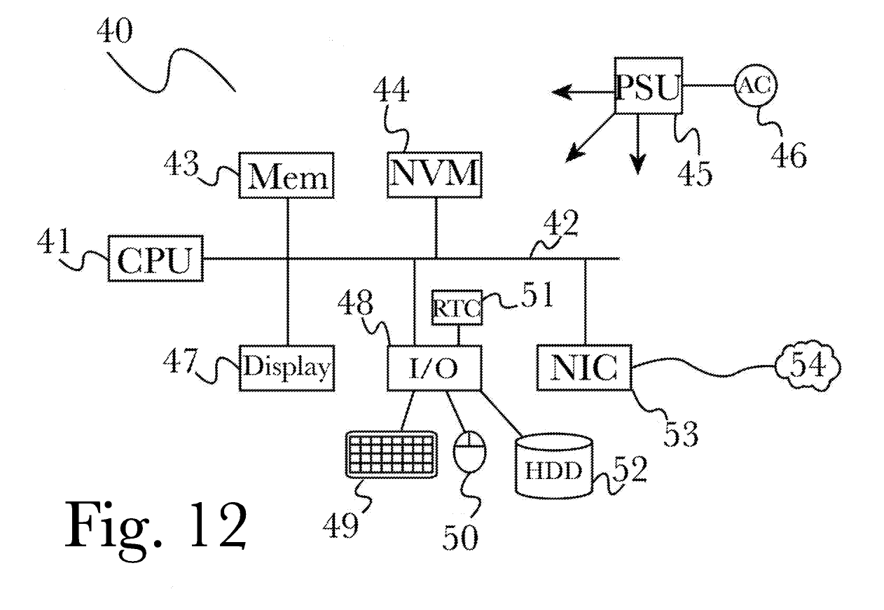

FIG. 12 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for cloud-connected, agent-based, next-generation endpoint protection, comprising:
a next-generation endpoint protection software agent comprising at least a processor, a memory, and a plurality of programming instructions stored in the memory, the plurality of programming instructions, when executed by the processor, cause the processor to:
collect process data comprising at least a plurality of processes operating on the processor;
transmit at least a portion of the process information to a remote remediation server;
receive instructions from a remote remediation server;
stop a process from operating on the processor based on the instructions received;
a remote mediation server comprising at least another processor, another memory, and another plurality of programming instructions stored in the another memory, the another plurality of programming instructions, when executed by the another processor, cause the another processor to:
receive at least a plurality of process data from a next-generation endpoint protection software agent;
analyze at least a portion of the process data; and
transmit instructions to the next-generation endpoint protection software agent, the instructions being based at least in part on the results of the analysis.

2. A method for cloud-connected, agent-based, next-generation endpoint protection, comprising the steps of:
collecting, at a next-generation endpoint protection software agent comprising at least a processor, a memory, and a plurality of programming instructions stored in the another memory, process data comprising at least a plurality of processes operating on the processor;
transmitting at least a portion of the process information to a remote remediation server;
receiving, at a remote mediation server comprising at least another processor, another memory, and another plurality of programming instructions stored in the another memory, at least a plurality of process data from a next-generation endpoint protection software agent;
analyzing at least a portion of the process data; and
transmitting instructions to the next-generation endpoint protection software agent, the instructions being based at least in part on the results of the analysis.
